(19) United States
(12) Patent Application Publication
(10) Pub. No.: US 2017/0235828 A1
(43) Pub. Date: Aug. 17, 2017

(54) Text Digest Generation For Searching Multiple Video Streams

(71) Applicant: Microsoft Technology Licensing, LLC, Redmond, WA (US)

(72) Inventors: Matthai Philipose, Seattle, WA (US); Lenin Ravindranath Sivalingam, Redmond, WA (US); Paramvir Bahl, Bellevue, WA (US); Yu-Han Chen, Taipei (TW)

(21) Appl. No.: 15/043,219

(22) Filed: Feb. 12, 2016

(51) Int. Cl. G06F 17/30; H04N 21/84; H04N 21/2665; G06K 9/00; H04N 21/234

(52) U.S. Cl. CPC G06F 17/30784; G06K 9/00718; H04N 21/23418; H04N 21/2665; H04N 21/84

(57) ABSTRACT

A digest generation system obtains video streams and includes an admission control module that selects, for each video stream, a subset of the frames of the video stream to analyze. A frame-to-text classifier generates a digest for each selected frame and the generated digests are stored in a digest store in a manner so that each digest is associated with the video stream from which the digest was generated. The digest for a frame is text that describes the frame, such as objects identified in the frame. A viewer desiring to view a video stream having particular characteristics inputs a text search query to a search system. The search system, based on the digests, generates search results that are an indication of video streams that satisfy the search criteria. The search results are presented to the user, allowing the user to select and view one of the video streams.

### BACKGROUND

As computing technology has advanced, computing devices have become increasingly present in our lives. Many people regularly carry portable computing devices such as smartphones, tablets, wearable devices, and so forth allowing them to capture video content. For example, a user may capture video content at various times as he goes through his day and upload this video content to a service where others can view the video content. This video content can also be a live stream, allowing other users to view the live stream approximately contemporaneously with the recording of the video content. Although such sharing of video content is useful, it is not without its problems. One such problem is that to search for relevant videos, viewers are typically forced to either search on the (often rudimentary) metadata information (e.g., tags) entered by the broadcaster, or visually browse through videos trying to find ones of interest. This can be burdensome on the viewers, which can lead to user frustration with their devices.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, multiple video streams are obtained. For each of the multiple video streams, a subset of frames of the video stream is selected and, for each frame in the subset of frames, a digest including text describing the frame is generated by applying a frame-to-text classifier to the frame. Additionally, a text search query is received, the digests of the multiple video streams are searched to identify a subset of the multiple video streams that satisfy the text search query, and an indication of the subset of video streams is returned.

In accordance with one or more aspects, a system includes an admission control module and a classifier module. The admission control module is configured to obtain multiple video streams and, for each of the multiple video streams, decode a subset of frames of the video stream. The classifier module is configured to generate, for each video stream, a digest for each decoded frame, the digest of a decoded frame including text describing the decoded frame. The system also includes a storage device configured to store the digests, as well as a query module configured to receive a text search query, search the digests stored in the storage device to identify a subset of the multiple video streams that satisfy the text search query, and return to a searcher an indication of the subset of live streams.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 illustrates an example system implementing the text digest generation for searching multiple video streams in accordance with one or more embodiments.

FIG. 2 illustrates aspects of an example system implementing the text digest generation for searching multiple video streams in additional detail in accordance with one or more embodiments.

FIG. 3 illustrates an example of the digests and digest store in accordance with one or more embodiments.

FIG. 4 is a flowchart illustrating an example process for implementing the text digest generation for searching multiple video streams in accordance with one or more embodiments.

FIG. 5 illustrates an example system that includes an example computing device that is representative of one or more systems and/or devices that may implement the various techniques described herein.

### DETAILED DESCRIPTION

Text digest generation for searching multiple video streams is discussed herein. Multiple different users can record video streams at various times. For example, some users desire to record and live stream parts of their day or particular activities. Live streaming refers to streaming video content from a video stream source (e.g., a user with a video stream source device such as a video camera) to one or more video stream viewers (e.g., another user with a video stream viewer device such as a computing device) so that the video stream viewer can see the streamed video content approximately contemporaneously with the capturing of the video content. Some lag or delay between capturing of the video content and viewing of the video content typically occurs as a result of processing the video content, such as encoding, transmitting, and decoding the video content. However, the live streamed video content is typically available for viewing shortly (e.g., within 10 to 60 seconds) of the video content being captured. The video content can be streamed from a video stream source device to a video stream viewer device via a streaming service, or alternatively directly from the video stream source device to the video stream viewer device.

Given the large number of users that may provide video streams and the large number of users that may desire to view these video streams, it can be computationally very expensive and/or burdensome to allow users to search for and identify video streams that are of interest. This is because to search for relevant video streams, viewers are typically forced to either search on the (often rudimentary) metadata information (e.g., tags) entered by the broadcaster or visually browse through video streams trying to find ones of interest. One solution to this problem is to avoid relying on the broadcaster to annotate the video streams, and to use computer vision techniques to automatically match users' textual queries to the content of the video streams. But this is computationally expensive and can cause long delays. For example, there may be millions of video streams and millions of users desiring to view different ones of those video streams at approximately the same time. The millions of users desiring to view video streams may provide search criteria, leading to many millions of comparisons between the search criteria and the video streams that are to be performed.

The techniques discussed herein provide a video stream analysis and search service that allows for quick searching of video streams. The video streams are provided to an admission control module of the analysis and search service. The admission control module selects, for each video stream, a subset of the frames of the video stream to analyze. A frame-to-text classifier generates a digest for each selected frame and the generated digests are stored in a digest store in a manner so that each digest is associated with the video stream from which the digest was generated. The digest for a frame is text (e.g., words or phrases) that describes the frame, such as objects identified in the frame. The frame-to-text classifier can optionally be modified so that the classifier is specialized for digest generation, with a different classifier optionally being generated for each different video stream (and modified so as to quickly and reliably generate the digest for the associated video stream at the current time).

A viewer desiring to view a video stream having particular characteristics (e.g., particular objects such as dogs, cats, sunsets, etc.) inputs a search query to a search system. The search query is a text search query, and the search system compares the text of the search query to the digests in the digest store. Search results are generated that are the video streams associated with the digests that satisfy the search criteria. The search results are presented to the user, allowing the user to select one of the video streams he or she desires to watch. In response to selection of a video stream from the search results, the selected video stream is streamed to the viewer's computing device for display.

The frame-to-text classifier also optionally stores, as part of or otherwise associated with the digest, various visual attributes of the text in the digest as it relates to the video stream. For example, if the digest includes text indicating a dog is included in the frame, then the visual attribute can be a size (e.g., an approximate number of pixels) of the identified dog in the frame. These visual attributes can be used when presenting the search results to determine a relevance of the video streams in the search results, and ordering the presentation of search results in order of their relevance.

The techniques discussed herein provide quick searching of multiple different video streams. The search query and digests are both text, allowing a text search to be performed that is typically much less computationally expensive in comparison to techniques that may attempt to analyze frames of each video stream to determine whether the frames represent an input search text. Various performance enhancement techniques are also used, including generating digests for less than all of the frames of each video stream, and the use of classifiers modified to improve the speed at which the video stream analysis is performed. The techniques discussed herein thus increase the performance of the system by reducing the amount of time consumed when searching for video streams.

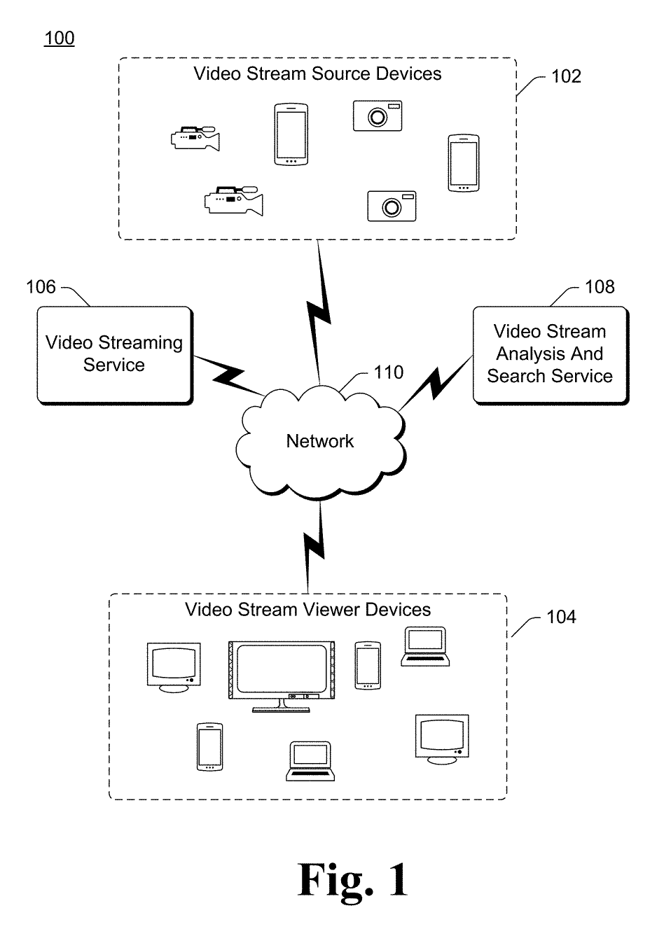

FIG. 1 illustrates an example system 100 implementing the text digest generation for searching multiple video streams in accordance with one or more embodiments. The system 100 includes multiple video stream source devices 102, each of which can be any of a variety of types of devices capable of capturing video content. Examples of such devices include a camcorder, a smartphone, a digital camera, a wearable device (e.g., eyeglasses, head-mounted display, watch, bracelet), a desktop computer, a laptop or netbook computer, a mobile device (e.g., a tablet or phablet device, a cellular or other wireless phone (e.g., a smartphone), a notepad computer, a mobile station), an entertainment device (e.g., an entertainment appliance, a set-top box communicatively coupled to a display device, a game console), Internet of Things (IoT) devices (e.g., objects or things with software, firmware, and/or hardware to allow communication with other devices), a television or other display device, an automotive computer, and so forth. Each video stream source device 102 can be associated with a user (e.g., glasses or a video camera that the user wears, a smartphone that the user holds). Alternatively, each video stream source device 102 can be independent of any particular user, such as a stationary video camera on a building's roof or overlooking an eagle's nest.

The system 100 also includes multiple video stream viewer devices 104, each of which can be any of a variety of types of devices capable of displaying video content. Examples of such devices include a television, a desktop computer, a laptop or netbook computer, a mobile device (e.g., a tablet or phablet device, a cellular or other wireless phone (e.g., a smartphone), a notepad computer, a mobile station), a wearable device (e.g., eyeglasses, head-mounted display, watch, bracelet), an entertainment device (e.g., an entertainment appliance, a set-top box communicatively coupled to a display device, a game console), IoT devices, a television or other display device, an automotive computer, and so forth. Each video stream viewer device 104 is typically associated with a user (e.g., a display of a computing device being used by a user to search for video content for viewing on the display).

Video content can be streamed from any of the video stream source devices 102 to any of the video stream viewer devices 104. Streaming of video content refers to transmitting the video content and allowing playback of the video content at a video stream viewer device 104 prior to all of the video content having been transmitted (e.g., the video stream viewer device 104 does not need to wait for the entire video content to be downloaded to the video stream viewer device 104 before beginning to display the video content). Video content transmitted in such a manner is also referred to as a video stream.

In one or more embodiments, the system 100 includes a video streaming service 106 that facilitates the streaming of video content from the video stream source devices 102 to the video stream viewer devices 104. Each video stream source device 102 can stream video content to the video streaming service 106, and the video streaming service 106 streams that video content to each of the video stream viewer devices 104 that desire the video content. Alternatively, no such video streaming service 106 may be used, and the video stream source devices 102 can stream video content to the video stream viewer devices 104 without using any intermediary video streaming service. Although reference is made herein to video streams, it should be noted that other types of media (e.g., audio content) can correspond to the video streams and be analogously streamed from a video stream source device 102 to a video stream viewer device 104 (separately from the video stream or concurrently with the video stream such as as part of multi-media streaming).

The system 100 also includes a video stream analysis and search service 108. The video stream analysis and search service 108 facilitates searching for video streams, and provides a search service allowing video stream viewers to search for video streams they desire. The video stream analysis and search service 108 generates text digests representing the video streams received from the video stream source devices 102 at any given time, and allows those text digests to be searched as discussed in more detail below.

The video stream source devices 102, video stream viewer device 104, video streaming service 106, and video stream analysis and search service 108 can communicate with one another via a network 110. The network 110 can be any of a variety of different networks including the Internet, a local area network (LAN), a phone network, an intranet, other public and/or proprietary networks, combinations thereof, and so forth.

The video streaming service 106 and the video stream analysis and search service 108 can each be implemented using any of a variety of different types of computing devices. Examples of such computing devices include a desktop computer, a server computer, a laptop or netbook computer, a mobile device (e.g., a tablet or phablet device, a cellular or other wireless phone (e.g., a smartphone), a notepad computer, a mobile station), a wearable device (e.g., eyeglasses, head-mounted display, watch, bracelet), an entertainment device (e.g., an entertainment appliance, a set-top box communicatively coupled to a display device, a game console), and so forth. The video streaming service 106 and the video stream analysis and search service 108 can each be implemented using multiple computing devices (of the same or different types), or alternatively using a single computing device.

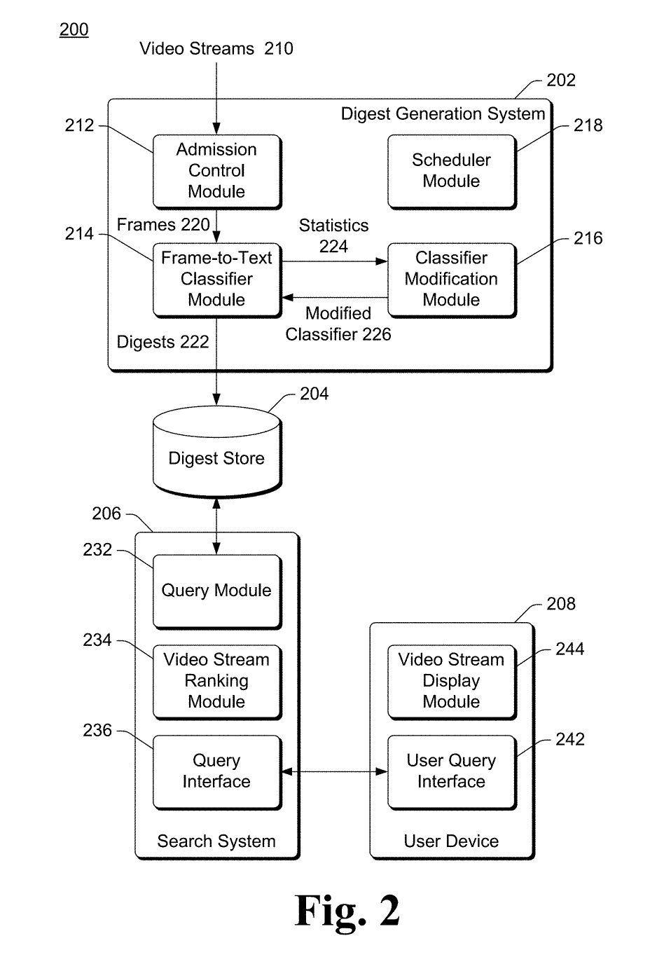

FIG. 2 illustrates aspects of an example system 200 implementing the text digest generation for searching multiple video streams in additional detail in accordance with one or more embodiments. The system 200 includes a digest generation system 202, a digest store 204, a search system 206, and a user device 208. Multiple video streams 210 are input to or otherwise obtained by the digest generation system 202. Each video stream 210 can be, for example, a video stream from a video stream source device 102 of FIG. 1.

The digest generation system 202 includes an admission control module 212, a frame-to-text classifier module 214, a classifier modification module 216, and a scheduler module 206. Each video stream 210 is a stream of video content that includes multiple frames. For example, the video stream can include 30 frames per second. Generally, for each video stream 210, the admission control module 212 selects a subset of the frames of the video stream 210 to analyze. The frame-to-text classifier 214 generates a digest for each selected frame and stores the generated digests in the digest store 204. The classifier modification module 216 optionally modifies the frame-to-text classifier module 214 so that the frame-to-text classifier module is specialized for generating digests, and optionally specialized for generating digests for a particular video stream 210. The scheduler module 218 optionally schedules different versions or copies of the frame-to-text classifier module 214 used to generate digests for different video streams 210 to run on particular computing devices, thereby distributing the computational load of generating the digests across multiple computing devices.

The admission control module 212 selects, for each video stream 210, a subset of the frames of the video stream 210 to analyze. By selecting a subset of the frames of each video stream 210 to analyze, the number of frames for which digests are generated by the frame-to-text classifier module 214 are reduced, thereby increasing the performance of the digest generation system 202 (as opposed to situations in which the frame-to-text classifier module 214 were to generate a digest for each frame of each video stream 210).

The admission control module 212 can use any of a variety of different techniques to determine which subset of frames of a video stream 210 to select. The admission control module 212 is designed to reduce the number of frames let through to the frame-to-text classifier module 214 while at the same time preserving most (e.g., at least a threshold percentage) of the relevant information content in the video stream 210. In one or more embodiments, the subset of frames is a uniform sampling of the frames of the video stream 210 (e.g., one frame out of every n frames, where n is any number greater than 1). Thus, for example, the admission control module 212 can select every 50^{th} frame, every 100^{th} frame, and so forth. The same uniform sampling rate can be used for all of the video streams 210, or different uniform sampling rates can be used for different video streams 210. The uniform sampling rate for a video stream 210 can also optionally vary over time.

Additionally or alternatively, other techniques can be used to determine which subset of frames of a video stream 210 to select. For example, the admission control module 212 can be implemented in a decoder component of the digest generation system 202. The decoder component can be implemented in hardware (e.g., in an application-specific integrated circuit (ASIC)), software, firmware, or combinations thereof. The frames of the video streams 210 are received in an encoded format, such as in a compressed format in order to reduce the size of the frames and thus the amount of time taken to transmit the frames (e.g., over the network 110 of FIG. 1). The decoder component is configured to decode the subset of frames of a video stream 210 and provide the decoded subset of frames to the frame-to-text classifier module 214.

The admission control module 212, as part of the decoder component, analyzes various information in the encoded frames to determine which frames the decoder component is to decode. For example, one or more of the encoded frames of a video stream can include a motion vector that indicates an amount of change in the data between that frame and one or more previous frames in the video stream. If the motion vector indicates a significant amount of change (e.g., the motion vector has a value that exceeds a threshold value) then the frame is selected as one of the subset of frames for which a digest is to be generated. However, if the motion vector does not indicate a significant amount of change (e.g., the motion vector has a value that does not exceed a threshold value) then the frame is not selected as one of the subset of frames for which a digest is to be generated. If the frame is not selected as one of the subset of frames for which a digest is to be generated, the frame can be dropped or otherwise ignored by the decoder component (e.g., the frame need not be decoded by the decoder component).

The frame-to-text classifier module 214 receives the selected subset of frames 220 from the admission control module 212. For each frame received from the admission control module 212, the frame-to-text classifier module 214 generates a digest for the frame and stores the generated digest in the digest store 204. The frame-to-text classifier module 214 can be any of a variety of different types of classifiers that, given a frame, provide a text description of the frame. The text description can include, depending on the particular frame, objects in the frame (e.g., buildings, signs, trees, dogs, cats, people, cars, etc.), adjectives describing the frame (e.g., colors identified in the frame, colors of particular objects in the frame, etc.), activities or actions in the frame (e.g., playing, swimming, running, etc.), and so forth. Various other information describing the frame can optionally be included in the text description of the frame, such as a mood or feeling associated with the frame, a brightness of the frame, and so forth.

In one or more embodiments, the frame-to-text classifier module 214 is implemented as a deep neural network. A deep neural network is an artificial neural network that includes an input layer and an output layer. The input layer receives the frame as an input, the output layer provides the text description of the frame, and multiple hidden layers between the input layer and the output layer that perform various analysis on the frame to generate the text description. The frame-to-text classifier module 214 can alternatively be implemented as any of a variety of other types of classifiers. For example, the frame-to-text classifier module 214 can be implemented using any of a variety of different clustering algorithms, any of a variety of regression algorithms, any of a variety of sequence labeling algorithms, and so forth.

In one or more embodiments, the frame-to-text classifier module 214 is trained to generate the text descriptions of frames. This training is performed by providing training data to the frame-to-text classifier module 214 that includes frames that have known text descriptions (e.g., known objects, known adjectives, known activities) as well as frames known to lack those text descriptions. The frame-to-text classifier module 214 uses this training data to automatically configure itself to generate the text descriptions. Any of a variety of public and/or proprietary techniques can be used to train the frame-to-text classifier module 214, and the specific manner in which the frame-to-text classifier module 214 is trained can vary based on the particular manner in which the frame-to-text classifier module 214 is implemented.

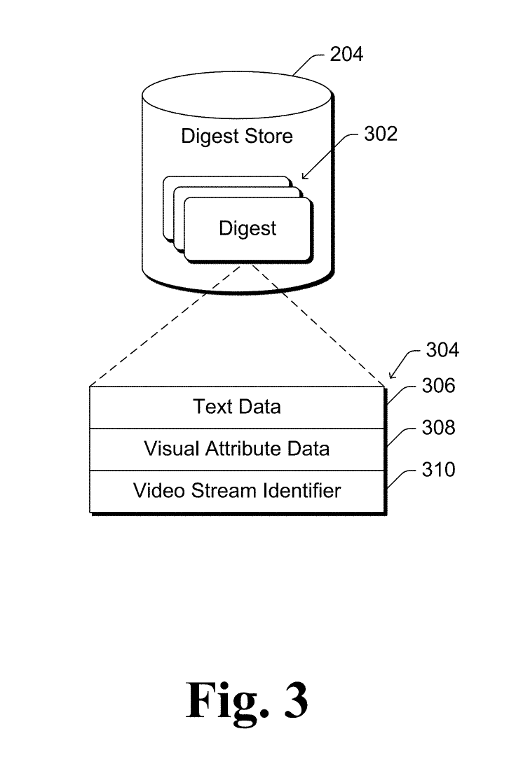

The frame-to-text classifier module 214 generates digests 222 and stores the digests in the digest store 204. FIG. 3 illustrates an example of the digests and digest store in accordance with one or more embodiments. The digest store 204 can be implemented using any of a variety of different storage mechanisms, such as Flash memory, magnetic disks, optical discs, and so forth.

The digest store 204 stores multiple digests 302. In one or more embodiments, the digest store 204 stores a digest generated from one frame of each of the video streams 210 of FIG. 2. For each video stream, the digest stored in the digest store 204 is the digest generated from the frame most recently selected from the video stream by the admission control module 212. Alternatively, for one or more of the video streams the digest store 204 stores multiple digests each of which is generated from a different frame of the video stream. For example, for one or more of the video streams the digests stored in the digest store 204 are the x (where x is greater than 1) digests generated from the x frames most recently selected from the video stream by the admission control module 212.

An example digest 304 is illustrated in FIG. 3. The digest 304 includes text data 306, which in one or more embodiments is the text generated by the frame-to-text classifier module 214 of FIG. 2. Additionally or alternatively, the text data 306 can be another value generated based on the text generated by the frame-to-text classifier module 214. For example, the text data 306 may be a hash value generated by applying a hash function to the text generated by the frame-to-text classifier module 214.

The digest 304 optionally includes visual attribute data 308, which is information describing various visual attributes of the text (or objects represented by the text) generated by the frame-to-text classifier module 214. The visual attribute data 308 can be generated by the frame-to-text classifier module 214, or alternatively by another module analyzing the frame (and optionally multiple previous frames) and the text generated by the frame-to-text classifier module 214.

The visual attribute data 308 is generated by applying any of a variety of different rules or criteria to the objects or other text generated by the frame-to-text classifier module 214. In one or more embodiments, the visual attribute data 308 indicates a size of a detected object in the frame. The size can be indicated in different manners, such as in pixels (e.g., approximately 200×300 pixels), a value relative to the whole frame (e.g., approximately 15% of the frame), and so forth.

Additionally or alternatively, rules or criteria can be applied to determine whether an object is in the foreground or background. Such a determination can be made in various manners, such as based on the size of the object relative to the sizes of other objects in the frame, whether portions of the object are obstructed by other objects, and so forth.

Additionally or alternatively, rules or criteria can be applied to determine a dwell time or a speed of an object in the frame. For example, a location of an object in the frame previously selected by the admission control module 212 can be compared to the location of the object in the frame currently selected by the admission control module 212. An indication of a speed of movement (e.g., a particular number of pixels per second) can be readily determined based on difference in location of the object in the two frames and the amount of time between the frames. By way of another example, an indication of a dwell time for an object can be determined based on how long the object has been in the frame. E.g., the visual attribute data 308 can include a timestamp indicating the date and/or time that an object is detected (e.g., the date and/or time that the frame including the object is received by the admission control module 212). When a new digest is generated for a video stream, if the object was present in the previously generated digest for the video stream then the timestamp indicating the date and/or time that the object was detected (as indicated in the visual attribute data 308 of the previously generated digest) can be copied over to the visual attribute data 308 of the new digest.

In one or more embodiments, the digest 304 also includes a video stream identifier 310. The video stream identifier 310 is an identifier of the video stream from which the frame used to generate the digest 304 is obtained. The video stream identifier 310 allows the video stream associated with the digest 304 to be readily identified if the digest 304 results in a match to search criteria as discussed in more detail below.

Additionally or alternatively, rather than including the video stream identifier 310 in the digest 304, an association between the digest 304 and the video stream from which the frame used to generate the digest 304 is obtained can be maintained in other manners. For example, a table or list of associations can be maintained, an indication of the video stream can be inherent in the record or file name used to store or identify the digest 304 in the digest store 204, and so forth.

Returning to FIG. 2, in one or more embodiments the frame-to-text classifier module 214 provides various statistics 224 to the classifier modification module 216, which can generate and provide one or more modified classifiers 226 to the frame-to-text classifier module 214. A modified classifier 226 can be used to replace or supplement a classifier implemented by the frame-to-text classifier module 214 to generate the digests 222. The statistics 224 refer to various information regarding the classification performed by the frame-to-text classifier module 214, such as what text is generated for digests of in frames of a video stream over a given period of time (e.g., the previous 10 or 20 minutes).

In one or more embodiments, the classifier modification module 216 generates a modified classifier 226 that is a reduced accuracy classifier. The reduced accuracy classifier refers to a classifier that uses lossy techniques that reduce classifier accuracy by a small amount (e.g., 2% to 5%) in exchange for large reductions in resource usage. Lossy techniques refer to techniques in which some data used by the classifier is lost, thereby reducing the accuracy of the classifier. Various different public and/or proprietary lossy techniques can be used, such as layer factorization in a classifier that is a deep neural network.

Additionally or alternatively, the classifier modification module 216 can generate a modified classifier 226 that is specialized for a particular media stream 210. One or more of the media streams 210 can each have their own specialized classifiers. A specialized classifier refers to a classifier that is trained based on the frames of the media stream being currently received (e.g., over the past 5 or 10 minutes). The frame-to-text classifier module 214 optionally includes a general classifier that is trained to generate many (e.g., 10,000-20,000 different text words or phrases) based on a frame. At any given time, however, typically only a small percentage of those words or phrases apply for a given video stream. For example, a general classifier may be able to identify (e.g., generate a text word or phrase for) 100 different types of animals, but when a user is at home for the evening he or she is likely to encounter no more than 5 different types of animals.

The statistics 224 identify which text is being generated by the frame-to-text classifier module 214, and the classifier modification module 216 applies various rules or criteria to the statistics 224 to analyze the text being generated. If the same text is generated on a regular basis (e.g., only a particular 100 text words or phrases have been generated for a threshold amount of time, such as 5 or 10 minutes) for a particular video stream then the classifier modification module 216 generates a classifier that is specialized for that particular video stream at the current time by training a classifier using that text that has been generated on a regular basis (e.g., the particular 100 text words or phrases). The specialized classifier is thus trained for that particular video stream but not other video streams.

It should be noted that the specialized classifier for a video stream may encounter an object that it cannot identify (e.g., cannot generate a text word or phrase for). In such situations, the general classifier is used on the frame. It should also be noted that over time the words or phrases that apply for a given video stream changes due to the video stream source device moving or the environment around the video stream source device changing. If the specialized classifier for a video stream encounters enough objects (e.g., at least a threshold number of objects) in a frame or in multiple frames that it cannot identify, then the frame-to-text classifier module 214 can cease using the specialized classifier and return to using the general classifier (e.g., until a new specialized classifier can be generated).

A cache of specialized classifiers can optionally be maintained by the classifier modification module 216. Each specialized classifier generated for a video stream can be maintained by the classifier modification module 216 for some amount of time (e.g., a few hours, a few days, or indefinitely). If the classifier modification module 216 detects that the same text is being generated on a regular basis (e.g., only a particular 100 text words or phrases have been generated for a threshold amount of time, such as 5 or 10 minutes) and that same text (e.g., the same particular 100 text words or phrases) has previously been used to train a specialized classifier for the video stream, then that previously trained and cached specialized classifier can be provided to the frame-to-text classifier module as a modified classifier 226.

In one or more embodiments, the classifier modification module 216 can also generate a modified classifier 216 that is customized to a particular one or more queries. For example, if at least a threshold percentage of search queries (as discussed in more detail below) are made up of some combination of a set of text words or phrases (e.g., a particular 200 text words or phrases), then a customized classifier can be generated that is trained on that set of text words or phrases (e.g., those particular 200 text words or phrases). This customized classifier is similar to the specialized classifiers discussed above, but is used for multiple video streams rather than being specialized for a single video stream.

By generating modified classifiers 226, the classifier modification module 216 reduces the computational resources used by the frame-to-text classifier module 214, thereby increasing the performance of the digest generation system 202. Specialized or customized classifiers for video streams, as discussed above, identify fewer text words or phrases and thus can be implemented with reduced complexity (and thus use fewer computational resources). Reduced accuracy classifiers, as discussed above, reduce classifier accuracy some in exchange for large reductions in resource usage, thereby reducing the computational resources expended by the frame-to-text classifier module 214.

The digest generation system 202 also optionally includes a scheduler module 218. The digest generation system 202 is able to receive large numbers (e.g., millions) of video streams 210, and thus parts of the digest generation system 202 may be distributed across different computing devices. In one or more embodiments multiple versions or copies of the frame-to-text classifier module 214 are distributed across multiple computing devices, each version or copy of the frame-to-text classifier module generating digests for a different subset of video streams 210. The scheduler module 218 applies various rules or criteria to determine which of the multiple computing devices generate digests for frames of which of the video streams 210. The number of video streams 210 in each such subset of video streams can vary (e.g., may be 100-1000) depending on how many versions or copies of the frame-to-text classifier module 214 (or how many classifiers) a computing device can run concurrently. In one or more embodiments, the number of video streams 210 in each such subset is selected so that the computing device is not expected to run more than a threshold number of classifiers concurrently. The admission control module 212 does not forward every frame of a video stream 210 to the frame-to-text classifier module 214, so it is expected that a version or copy of the frame-to-text classifier module 214 need not be desired to be run at the same time for all of the video streams received by the computing device.

It should be noted that, in situations in which the admission control module 212 uses uniform sampling, the video streams can be input to different ones of the computing devices implementing the digest generation system 202 based on this uniform sampling. For example, assume a computing device can run only one version or copy of a frame-to-text classifier module 214 at a time, and that admission control module 212 samples frames at a rate of 1 every 60 frames, then the video streams 210 can be assigned to computing devices so that one computing device receives a video stream that is sampled on the 1^{st}, 61^{st}, 121^{st}, etc. frames, another video stream that is sampled on the 3^{rd}, 63^{rd}, 123^{rd}, etc. frames, another video stream that is sampled on the 5^{th}, 65^{th}, 125^{th}, etc. frames, and so forth. Due to the staggered nature of these samplings, the computing device is not expected to be trying to run multiple versions or copies of the frame-to-text classifier module 214 to generate digests for multiple video streams concurrently.

It should also be noted that, if specialized classifiers as discussed above are used by the digest generation system 202, situations can arise in which a particular specialized classifier is not able to run because the computing device that the particular specialized classifier is to run on is already at capacity (and cannot currently run another). In such situations, rather than waiting until the computing device is able to run the particular specialized classifier, the scheduler module 218 can assign the particular specialized classifier to a different computing device to run. Additionally or alternatively, rather than waiting for the particular specialized classifier to be loaded and run on a different computing device, the scheduler module 218 runs a general classifier (e.g., that has already been loaded) on a computing device for the video stream rather than the particular specialized classifier for the video stream. Once the particular specialized classifier is loaded on a computing device, the scheduler module 218 can run the particular specialized classifier for the video stream rather than the general classifier.

Additionally, in one or more embodiments the scheduler module 218 takes into account computational resource (e.g., processor time) usage by the different copies or versions of the frame-to-text classifier module 214. For example, depending on the type of modification performed by the classifier modification module 216, some classifiers use significantly more computational resources to run than others. The scheduler module 218 can estimate variations in computational resource usage of modified classifiers by examining the structures of the classifiers. The scheduler module 218 can group together classifiers that have complementary structurally-estimated computational resource usage patterns onto the same computing device.

Furthermore, the computational resources expended in the classification performed by the frame-to-text classifier module 214 may be input dependent. For example, if there are many objects in the frame it may take longer to analyze the frame than if there are fewer objects in the frame. The scheduler module 218 can predict the computational resources usage for different video streams by applying various rules or criteria to their selected frames 220. For example, video streams for which a large number of objects have been identified (e.g., greater than a threshold number of text words or phrases have been generated) are predicted to use more computational resources than video streams for which a large number of objects have not been identified (e.g., less than a threshold number of text words or phrases have been generated). The scheduler module 218 can group together classifiers that have complementary predicted computational resource usage onto the same computing device.

In one or more embodiments, various aspects of the digest generation system 202 can be implemented in hardware. For example, the admission control module 212 can optionally be implemented in a decoder component as discussed above. Other modules of the digest generation system 202 can optionally be implemented in hardware as well. For example, the frame-to-text classifier module 214 may include a classifier that is implemented in hardware, such as in an ASIC, in a field-programmable gate array (FPGA), and so forth.

Thus, digests for the video streams 210 are generated by the digest generation system 202 and stored in the digest store 204. The search system 206 also accesses the digest store 204 to handle search queries, allowing users to search for particular video streams based on the digests in the digest store 204.

The search system 206 includes a query module 232, a video stream ranking module 234, and a query interface 236. The query interface 236 receives a text search query from the user device 208, the text search query being text describing types of video streams that a searcher (e.g., the user of the user device 208) is interested in. For example, a searcher interested in viewing video streams of children playing with dogs could provide a text search query of “child dog play”.

The query module 232 searches the digest stores 204 for digests that match the text search query (and thus for video streams (as identified by or otherwise associated with the digests) that match the text search query). In one or more embodiments, a digest matches the text search query if the digest (e.g., the text data 306 of FIG. 3) includes all of the words in the text search query. Additionally or alternatively, a digest matches the text search query if the digest includes at least a threshold number or percentage of the words or phrases in the text search query. Various wildcard values can also be included in the text search query, such as an asterisk to represent any zero or more characters, a question mark to represent any single character, and so forth.

In situations in which the digest stores another value (e.g., a hash value) that has been generated based on the text generated by the frame-to-text classifier module as discussed above, then another value is generated for the text search query in the same manner. This other value is then used to determine which digests match the text search query. For example, if hash values are stored in the digests, then hash values are generated for the text search query and compared to the hash values of the digests to determine which digests match text search query (e.g., have the same hash value as the text search query).

The query module 232 provides the digests that match the text search query to the video stream ranking module 234. The video stream ranking module 234 ranks the digests (also referred to as ranking the video streams associated with the digests) in accordance with their relevance to the text search query. The relevance of a digest to the text search query is determined by applying one or more rules or criteria to the visual attribute data of the digests and the text search query. Various different rules or criteria can be used to determine the relevance of a digest. For example, if the text search query includes the word “dog”, and if the visual attribute data of a digest indicates that an object identified as a “dog” is in the background of the frame, then that digest is considered to be of lower relevance than a digest having visual attribute data indicating that an object identified as a “dog” is in the foreground of the frame. By way of another example, if the text search query includes the word “car”, and if the visual attribute data of a digest indicates that an object identified as a “car” is in the frame and moving quickly (e.g., greater than a threshold number of pixels per second, such as 20 pixels per second), then that digest is considered to be of lower relevance than a digest having visual attribute data indicating that an object identified as a “car” is in the frame and moving slowly (e.g., less than another threshold number of pixels per second, such as 5 pixels per second) because it is assumed that a fast moving car may no longer be visible in the video stream by the time the user selects to view that video stream and transmission of the selected video stream to the searcher's device begins.

The video stream ranking module 234 sorts or ranks the digests based on their relevances, such as from most relevant to least relevant. The video stream ranking module 234 can also use the relevance of each of the digests as a filter. For example, the query module 232 may identify 75 video streams that satisfy the text search query, but the search system 206 may impose a limit of 25 video streams on the search results that are returned to the user device 208. In such situations, the video stream ranking module 234 can select the 25 video streams having the highest relevances as the video streams to include in the search results.

The query interface 236 returns the search results to the user device 208. In one or more embodiments, the search results are identifiers of the video streams associated with the digests that satisfy the text search query (as determined by the query module 232) and that have optionally been sorted and filtered based on relevance by the video stream ranking module 234. Alternatively, the search results can take other forms. For example, the search results can be the digests that satisfy the text search query (as determined by the query module 232) and that have optionally been sorted and filtered based on relevance by the video stream ranking module 234.

The user device 208 can be any of a variety of different devices used to view video streams, such as a video stream viewer device 104 of FIG. 1. The user device 208 includes a user query interface 242 and a video stream display module 244. The user provides a text search query to the user query interface 242 by providing any of a variety of different inputs, such as typing the text search query on a keyboard, selecting from a list of previously generated or suggested text search queries, providing a voice input of the text search query, and so forth. Additionally or alternatively, the text search query can be input by another component or module of the user device 208 rather than a user of the user device 208.

The user query interface 242 provides the text search query to the query interface 236 of the search system 206, and receives search results in response as discussed above. The video streams indicated in the search results can then be obtained and displayed by the user device 208 given the identifiers of the video streams that are included in the search results. In one or more embodiments, indications of the video streams identified by the search results (e.g., included in the search results or identified by digests included in the search results) are displayed or otherwise presented by the video stream display module 244 in their sorted or ranked order (as determined by the video stream ranking module 234). The indications of the video streams presented by the video stream display module 244 can take various forms. In one or more embodiments, the indications of the video streams are thumbnails displaying the video streams, which can be still thumbnails (e.g., a single frame of the video stream obtained from the video stream source device or a video streaming service), or can be the actual video streams (e.g., obtained from the video stream source device or a video streaming service). The user can then select one of the thumbnails in any of a variety of manners (e.g., touching the thumbnail, clicking on the thumbnail, providing a voice input identifying the thumbnail, etc.), in response to which the video stream indicated by the selected thumbnail is provided to the user device (e.g., from the video stream source device or a video streaming service) and displayed by the video stream display module 244.

In one or more embodiments, a request to search for video streams by a user of the user device 208 is a single search. In such situations, the query module 232 searches the digest store 204 and the query interface 236 returns the search results (optionally sorted and/or filtered by the video stream ranking module 234) to the user query interface 242. Alternatively, the request to search for video streams by a user of the user device 208 is a repeating search. In such situations, at regular or irregular intervals (e.g., every 30 seconds) the query module 232 searches the digest store 204 and the query interface 236 returns the search results (optionally sorted and/or filtered by the video stream ranking module 234) to the user query interface 242. The search is thus repeated, with possibly different search results after each search given changes to the digests in the digest store 204.

The searching for video streams is thus done on a text basis, with a text search query and text data in the digests generated for frames of the video streams. The searching is based on analysis of the frames of the video streams by the frame-to-text classifier module as discussed above rather than based on metadata added to a video stream by a broadcaster or other user. The searching techniques discussed herein provide faster and more reliable performance given the large number of video streams that may be searched than metadata added to a video stream by a broadcaster or other user would allow. The searching is also done based on a text search query rather than by having the user provide an image and search for video streams that are similar to the image. The searching techniques discussed herein provide faster performance given the large number of video streams that may be searched than searching for similar images would allow.

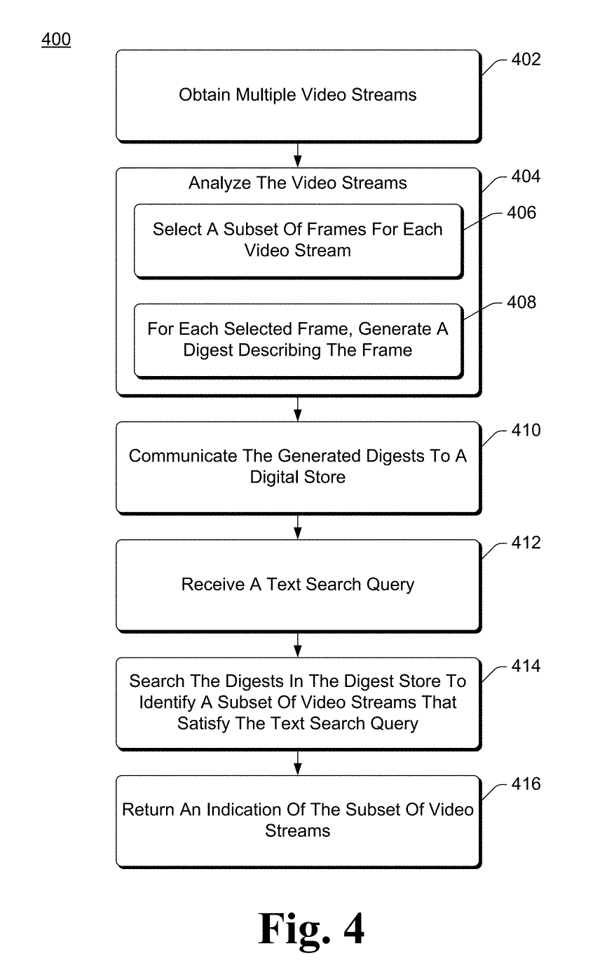

FIG. 4 is a flowchart illustrating an example process 400 for implementing the text digest generation for searching multiple video streams in accordance with one or more embodiments. Process 400 is carried out by one or more devices, such as one or more device implementing a video stream analysis and search service 108 of FIG. 1, or implementing a digest generation system 202, digest store 204, and/or search system 206 of FIG. 2. Process 400 can be implemented in software, firmware, hardware, or combinations thereof. Process 400 is shown as a set of acts and is not limited to the order shown for performing the operations of the various acts. Process 400 is an example process for implementing the text digest generation for searching multiple video streams; additional discussions of implementing the text digest generation for searching multiple video streams are included herein with reference to different figures.

In process 400, multiple video streams are obtained (act 402). The multiple video streams can be obtained in various manners, such as from the video stream source devices, from a video streaming service, and so forth.

The video streams are analyzed (act 404). The analysis of the video streams includes selecting a subset of frames for each video stream (act 406). This subset can be selected in various manners, such as using uniform sampling or using other rules or criteria as discussed above. The analysis also includes, for each selected frame, generating a digest describing the frame (act 408). The digest is a text description of the frame (e.g., one or more text words or phrases). The digest can optionally include additional information, such as visual attributes of the frame as discussed above.

The generated digests are communicated to a digest store (act 410). In one or more embodiments, only the most recently generated digest for each video stream is maintained in the digest store—each time a new digest is generated for a video stream the previously generated digest for the video stream is removed from the digest store. Alternatively, multiple previously generated digests for each video stream can be maintained in the digest store.

At some point, a text search query is received (act 412). The text search query is received from a user device. The text search query can be a user-input text search query, or alternatively an automatically generated text search query (e.g., generated by a module or component of the user device).

The digests in the digest store are searched to identify a subset of video streams that satisfy the text search query (act 414). A video stream satisfies the text search query if, for example, the digest associated with the video stream includes all (or at least a threshold amount) of the words or phrases in the text search query.

An indication of the subset of video streams is returned to the user device as search results (act 416). These search results can optionally be filtered and/or sorted based on relevance as discussed above.

Returning to FIG. 2, the video streams discussed herein can be live streams, which are video streams that are streamed from a video stream source device to one or more video stream viewer devices so that the video stream viewer can see the streamed video content approximately contemporaneously with the capturing of the video content. In such situations, the digest store 204 can maintain only the most recently generated digest for each video stream is maintained in the digest store.

Additionally or alternatively, the techniques discussed herein can be used to support the streaming of older (e.g., earlier in the day, earlier in the week) video streams. Video streams from a video stream source device can be stored by a service, such as the video streaming service 106 of FIG. 1. In such situations, digests over some duration of time (e.g., as far back temporally as searching of the video streams is desired) are maintained in the digest store 204. A timestamp can also be included in each digest, the timestamp indicating the date and/or time that the frame of the video from which the digest was generated was captured (or alternatively received or analyzed by the digest generation system 202). Previous segments or portions of the video stream can thus be searched by searching the digests, and the segment or portion that satisfies the segment can be readily identified given the timestamps in the digests. These previous segments or portions of the video stream can thus be searched for and played back analogous to the discussions above.

In the discussions herein, the visual attribute data is discussed as being included in the digests generated by the frame-to-text classifier module 214. Additionally or alternatively, the visual attribute data can be maintained in other locations, such as a separate store or record that maintains visual attribute data for the frames and/or for a video stream as a whole.

In the discussions herein, reference is made to the digests being generated by the digest generation system 202. Additionally or alternatively, the digests can be generated by other systems. For example, a video stream source device 102 of FIG. 1 can generate the digests for that video stream being streamed by that device 102 and communicate those digests to the digest generation system 202.

Although particular functionality is discussed herein with reference to particular modules, it should be noted that the functionality of individual modules discussed herein can be separated into multiple modules, and/or at least some functionality of multiple modules can be combined into a single module. Additionally, a particular module discussed herein as performing an action includes that particular module itself performing the action, or alternatively that particular module invoking or otherwise accessing another component or module that performs the action (or performs the action in conjunction with that particular module). Thus, a particular module performing an action includes that particular module itself performing the action and/or another module invoked or otherwise accessed by that particular module performing the action.

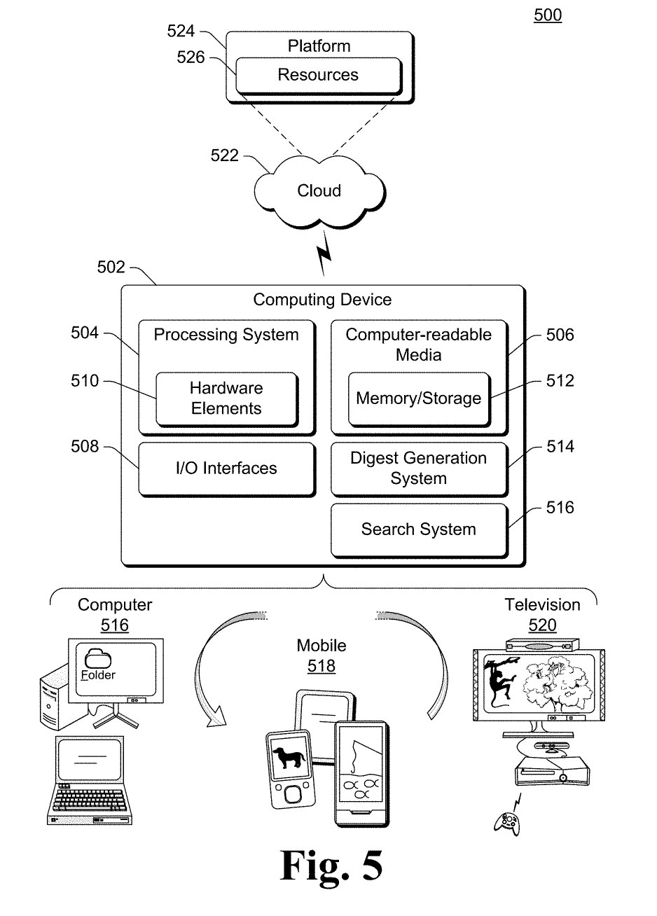

FIG. 5 illustrates an example system generally at 500 that includes an example computing device 502 that is representative of one or more systems and/or devices that may implement the various techniques described herein. The computing device 502 may be, for example, a server of a service provider, a device associated with a client (e.g., a client device), an on-chip system, and/or any other suitable computing device or computing system.

The example computing device 502 as illustrated includes a processing system 504, one or more computer-readable media 506, and one or more I/O Interfaces 508 that are communicatively coupled, one to another. Although not shown, the computing device 502 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 504 is representative of functionality to perform one or more operations using hardware. Accordingly, the processing system 504 is illustrated as including hardware elements 510 that may be configured as processors, functional blocks, and so forth. This may include implementation in hardware as an application specific integrated circuit or other logic device formed using one or more semiconductors. The hardware elements 510 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 506 is illustrated as including memory/storage 512. The memory/storage 512 represents memory/storage capacity associated with one or more computer-readable media. The memory/storage 512 may include volatile media (such as random access memory (RAM)) and/or nonvolatile media (such as read only memory (ROM), Flash memory, optical disks, magnetic disks, and so forth). The memory/storage 512 may include fixed media (e.g., RAM, ROM, a fixed hard drive, and so on) as well as removable media (e.g., Flash memory, a removable hard drive, an optical disc, and so forth). The computer-readable media 506 may be configured in a variety of other ways as further described below.

The one or more input/output interface(s) 508 are representative of functionality to allow a user to enter commands and information to computing device 502, and also allow information to be presented to the user and/or other components or devices using various input/output devices. Examples of input devices include a keyboard, a cursor control device (e.g., a mouse), a microphone (e.g., for voice inputs), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 502 may be configured in a variety of ways as further described below to support user interaction.

The computing device 502 also includes a digest generation system 514 and a search system 516. The digest generation system 514 generates digests for video streams, and the search system 516 supports searching for video streams based on the digests as discussed above. The digest generation system 514 can be, for example, the digest generation system 202 of FIG. 2, and the search system 516 can be, for example, the search system 206 of FIG. 2. Although the computing device 502 is illustrated as including both the digest generation system 514 and the search system 516, alternatively the computing device 502 may include only the digest generation system 514 (or a portion thereof) or only the search system 516 (or a portion thereof).

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of computing platforms having a variety of processors.

An implementation of the described modules and techniques may be stored on or transmitted across some form of computer-readable media. The computer-readable media may include a variety of media that may be accessed by the computing device 502. By way of example, and not limitation, computer-readable media may include “computer-readable storage media” and “computer-readable signal media.”

“Computer-readable storage media” refers to media and/or devices that enable persistent storage of information and/or storage that is tangible, in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 502, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, the hardware elements 510 and computer-readable media 506 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 510. The computing device 502 may be configured to implement particular instructions and/or functions corresponding to the software and/or hardware modules. Accordingly, implementation of modules as a module that is executable by the computing device 502 as software may be achieved at least partially in hardware, e.g., through use of computer-readable storage media and/or hardware elements 510 of the processing system. The instructions and/or functions may be executable/operable by one or more articles of manufacture (for example, one or more computing devices 502 and/or processing systems 504) to implement techniques, modules, and examples described herein.

As further illustrated in FIG. 5, the example system 500 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 500, multiple devices are interconnected through a central computing device. The central computing device may be local to the multiple devices or may be located remotely from the multiple devices. In one or more embodiments, the central computing device may be a cloud of one or more server computers that are connected to the multiple devices through a network, the Internet, or other data communication link.

In one or more embodiments, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one or more embodiments, a class of target devices is created and experiences are tailored to the generic class of devices. A class of devices may be defined by physical features, types of usage, or other common characteristics of the devices.

In various implementations, the computing device 502 may assume a variety of different configurations, such as for computer 516, mobile 518, and television 520 uses. Each of these configurations includes devices that may have generally different constructs and capabilities, and thus the computing device 502 may be configured according to one or more of the different device classes. For instance, the computing device 502 may be implemented as the computer 516 class of a device that includes a personal computer, desktop computer, a multi-screen computer, laptop computer, netbook, and so on.

The computing device 502 may also be implemented as the mobile 518 class of device that includes mobile devices, such as a mobile phone, portable music player, portable gaming device, a tablet computer, a multi-screen computer, and so on. The computing device 502 may also be implemented as the television 520 class of device that includes devices having or connected to generally larger screens in casual viewing environments. These devices include televisions, set-top boxes, gaming consoles, and so on.

The techniques described herein may be supported by these various configurations of the computing device 502 and are not limited to the specific examples of the techniques described herein. This functionality may also be implemented all or in part through use of a distributed system, such as over a “cloud” 522 via a platform 524 as described below.

The cloud 522 includes and/or is representative of a platform 524 for resources 526. The platform 524 abstracts underlying functionality of hardware (e.g., servers) and software resources of the cloud 522. The resources 526 may include applications and/or data that can be utilized while computer processing is executed on servers that are remote from the computing device 502. Resources 526 can also include services provided over the Internet and/or through a subscriber network, such as a cellular or Wi-Fi network.

The platform 524 may abstract resources and functions to connect the computing device 502 with other computing devices. The platform 524 may also serve to abstract scaling of resources to provide a corresponding level of scale to encountered demand for the resources 526 that are implemented via the platform 524. Accordingly, in an interconnected device embodiment, implementation of functionality described herein may be distributed throughout the system 500. For example, the functionality may be implemented in part on the computing device 502 as well as via the platform 524 that abstracts the functionality of the cloud 522.

In the discussions herein, various different embodiments are described. It is to be appreciated and understood that each embodiment described herein can be used on its own or in connection with one or more other embodiments described herein. Further aspects of the techniques discussed herein relate to one or more of the following embodiments.

A method comprising: obtaining multiple video streams; for each of the multiple video streams: selecting a subset of frames of the video stream; and generating, for each frame in the subset of frames by applying a frame-to-text classifier to the frame, a digest including text describing the frame; receiving a text search query; searching the digests of the multiple video streams to identify a subset of the multiple video streams that satisfy the text search query; and returning an indication of the subset of video streams.

Alternatively or in addition to any of the above described methods, any one or combination of: the multiple video streams comprising multiple live streams each received from a different one of multiple video stream source devices; the selecting the subset of frames comprising performing a uniform sampling of frames of the video stream; the generating comprising generating the digest using a reduced accuracy classifier that employs lossy techniques; the generating comprising generating the digest using a specialized classifier for the video stream that is trained for the video stream but not trained for other video streams; the method further comprising generating visual attributes for the text describing the frame, and using the generated visual attributes to determine a relevance of the video stream to the text search query; the using the generated visual attributes including sorting, in order of their relevance, identifiers of the video streams in the subset of video streams.

A system comprising: an admission control module configured to obtain multiple video streams and, for each of the multiple video streams, decode a subset of frames of the video stream; a classifier module configured to generate, for each video stream, a digest for each decoded frame, the digest of a decoded frame including text describing the decoded frame; a storage device configured to store the digests; and a query module configured to receive a text search query, search the digests stored in the storage device to identify a subset of the multiple video streams that satisfy the text search query, and return to a searcher an indication of the subset of live streams.

Alternatively or in addition to any of the above described systems, any one or combination of: the system being implemented on a single computing device; the system further comprising a scheduler module, multiple classifiers for the multiple video streams, and multiple computing devices, the scheduler module determining which of the multiple computing devices include classifiers to generate digests for frames of which of the multiple video streams; the admission control module being further configured to select the subset of frames by performing a uniform sampling of the frames of the video stream; the classifier module being further configured to generate visual attributes for the text describing the frame, and the query module being further configured to use the generated visual attributes to determine a relevance of the video stream to the text search query; the multiple video streams comprising multiple live streams each received from a different one of multiple video stream source devices; the classifier module configured to generate the digest using a specialized classifier for the video stream that is trained for the video stream but not trained for other ones of the multiple video streams.

A computing device comprising: one or more processors; and a computer-readable storage medium having stored thereon multiple instructions that, responsive to execution by the one or more processors, cause the one or more processors to perform acts comprising: obtaining multiple video streams; and for each of the multiple video streams: selecting a subset of frames of the video stream; generating, for each frame in the subset of frames by applying a frame-to-text classifier to the frame, a digest including text describing the frame; and communicating, to a digest store, the generated digests.

Alternatively or in addition to any of the above described computing devices, any one or combination of: the acts further comprising receiving a text search query, searching the digests in the digest store to identify a subset of the multiple video streams that satisfy the text search query, and returning an indication of the subset of video streams; the multiple video streams comprising multiple live streams each received from a video stream source device of a different one of multiple users; the selecting the subset of frames comprising performing a uniform sampling of frames of the video stream; the generating comprising generating the digest using a reduced accuracy classifier that employs lossy techniques; the generating comprising generating the digest using a specialized classifier for the video stream that is trained for the video stream but not trained for other video streams.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
obtaining multiple video streams;
for each of the multiple video streams:
selecting a subset of frames of the video stream; and
generating, for each frame in the subset of frames by applying a frame-to-text classifier to the frame, a digest including text describing the frame;
receiving a text search query;
searching the digests of the multiple video streams to identify a subset of the multiple video streams that satisfy the text search query; and
returning an indication of the subset of video streams.

2. The method as recited in claim 1, the multiple video streams comprising multiple live streams each received from a different one of multiple video stream source devices.

3. The method as recited in claim 1, the selecting the subset of frames comprising performing a uniform sampling of frames of the video stream.

4. The method as recited in claim 1, the generating comprising generating the digest using a reduced accuracy classifier that employs lossy techniques.

5. The method as recited in claim 1, the generating comprising generating the digest using a specialized classifier for the video stream that is trained for the video stream but not trained for other video streams.

6. The method as recited in claim 1, further comprising generating visual attributes for the text describing the frame, and using the generated visual attributes to determine a relevance of the video stream to the text search query.

7. The method as recited in claim 6, the using the generated visual attributes including sorting, in order of their relevance, identifiers of the video streams in the subset of video streams.

8. A system comprising:
an admission control module configured to obtain multiple video streams and, for each of the multiple video streams, decode a subset of frames of the video stream;
a classifier module configured to generate, for each video stream, a digest for each decoded frame, the digest of a decoded frame including text describing the decoded frame;
a storage device configured to store the digests; and
a query module configured to receive a text search query, search the digests stored in the storage device to identify a subset of the multiple video streams that satisfy the text search query, and return to a searcher an indication of the subset of live streams.

9. The system as recited in claim 8, the system being implemented on a single computing device.

10. The system as recited in claim 8, the system further comprising a scheduler module, multiple classifiers for the multiple video streams, and multiple computing devices, the scheduler module determining which of the multiple computing devices include classifiers to generate digests for frames of which of the multiple video streams.

11. The system as recited in claim 8, the admission control module being further configured to select the subset of frames by performing a uniform sampling of the frames of the video stream.

12. The system as recited in claim 8, the classifier module being further configured to generate visual attributes for the text describing the frame, and the query module being further configured to use the generated visual attributes to determine a relevance of the video stream to the text search query.

13. The system as recited in claim 8, the multiple video streams comprising multiple live streams each received from a different one of multiple video stream source devices.

14. The system as recited in claim 8, the classifier module configured to generate the digest using a specialized classifier for the video stream that is trained for the video stream but not trained for other ones of the multiple video streams.

15. A computing device comprising:
one or more processors; and
a computer-readable storage medium having stored thereon multiple instructions that, responsive to execution by the one or more processors, cause the one or more processors to perform acts comprising:
obtaining multiple video streams; and
for each of the multiple video streams:
selecting a subset of frames of the video stream;
generating, for each frame in the subset of frames by applying a frame-to-text classifier to the frame, a digest including text describing the frame; and
communicating, to a digest store, the generated digests.

16. The computing device as recited in claim 15, the acts further comprising:
receiving a text search query;
searching the digests in the digest store to identify a subset of the multiple video streams that satisfy the text search query; and
returning an indication of the subset of video streams.

17. The computing device as recited in claim 15, the multiple video streams comprising multiple live streams each received from a video stream source device of a different one of multiple users.

18. The computing device as recited in claim 15, the selecting the subset of frames comprising performing a uniform sampling of frames of the video stream.

19. The computing device as recited in claim 15, the generating comprising generating the digest using a reduced accuracy classifier that employs lossy techniques.

20. The computing device as recited in claim 15, the generating comprising generating the digest using a specialized classifier for the video stream that is trained for the video stream but not trained for other video streams.
